(19) United States
(12) Patent Application Publication
(10) Pub. No.: US 2009/0098391 A1
(43) Pub. Date: Apr. 16, 2009

(54) CORE MEMBER AND METHOD OF PRODUCING THE SAME

(75) Inventors: Takashi NAKAGAWA, Kawasaki (JP); Kenji IIDA, Kawasaki (JP); Yasutomo MAEHARA, Kawasaki (JP); Shin HIRANO, Kawasaki (JP); Tomoyuki ABE, Kawasaki (JP); Hideaki YOSHIMURA, Kawasaki (JP); Seigo YAMAWAKI, Kawasaki (JP); Norikazu OZAKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/188,759

(22) Filed: Aug. 8, 2008

(30) Foreign Application Priority Data
Oct. 12, 2007 (JP) 2007-267122

(51) Int. Cl. B32B 5/28; B32B 37/04

(52) U.S. Cl. 428/433; 156/306.9

(57) ABSTRACT

The core member constitutes a core substrate of a circuit board. The core member comprises: a carbon fiber-reinforced core section, in which prepregs including carbon fibers are thermocompression-bonded; and copper foils being respectively thermocompression-bonded on the both side faces of the carbon fiber-reinforced core section with prepregs including glass fibers. The pregregs including glass fibers are composed of resin, whose melting temperature range is higher than that of resin composing the pregregs including carbon fibers.

### BACKGROUND OF THE INVENTION

The present invention relates to a core member, which constitutes a core substrate of a circuit board, and a method of producing the core member.

Some multi-layered circuit boards, on which semiconductor elements will be mounted, have core substrates including carbon fiber-reinforced core sections (see JP Kohyo Gazette No. 2004/064467). Thermal expansion coefficients of the core substrates including the carbon fiber-reinforced core sections are smaller than those of conventional plastic core substrates. Therefore, thermal expansion coefficients of the circuit boards having such core substrates can be effectively corresponded to those of semiconductor elements to be mounted on the circuit boards.

Namely, thermal expansion coefficients of the plastic core substrates are 13-14 ppm/° C., those of the carbon fiber-reinforced core sections are much smaller, e.g., 1-2 ppm/° C., and those of semiconductor elements are about 3.5 ppm/° C. Therefore, the thermal expansion coefficients of the circuit boards can be corresponded to those of the semiconductor elements by adjusting thermal expansion coefficients of cable layers and insulating layers.

For example, in case of mounting a semiconductor element on a circuit board by a flip chip bonding method, a thermal expansion coefficient of the semiconductor element is different from that of the circuit board, so the circuit board has following disadvantages. Namely, a great thermal stress is applied to the semiconductor element, thereby the semiconductor element is damaged and connection reliability therebetween is lowered. In the core substrate including the carbon fiber-reinforced core section, the thermal stress applied to the semiconductor element is restrained by corresponding the thermal expansion coefficient of the semiconductor element to that of the circuit board, so that reliability of an electronic device can be improved.

The carbon fiber-reinforced core section of the core substrate is formed by the steps of: laminating a plurality of prepregs, which are formed by impregnating carbon fibers with resin, e.g., epoxy resin; and heating and pressurizing the laminated prepregs so as to integrate them. In the heating and pressurizing step, a core member is formed by bonding copper foils on the both side faces of the integrated prepregs. Cable layers are laminated on the both side faces of the core member so as to form the core substrate. Further, cable layers are laminated on the both side faces of the core substrate so as to form the circuit board. Therefore, the core member acts as a supporting body and must have predetermined strength.

### SUMMARY OF THE INVENTION

The present invention was conceived to solve the above described problems.

An object of the present invention is to provide a core member, which constitutes a core substrate of a circuit board and whose core section includes carbon fibers.

Another object of the present invention is to provide a method of said core section.

To achieve the objects, the present invention has following constitutions.

Namely, the core member of the present invention comprises: a carbon fiber-reinforced core section, in which prepregs including carbon fibers are thermocompression-bonded; and copper foils being respectively thermocompression-bonded on the both side faces of the carbon fiber-reinforced core section with prepregs including glass fibers, and the pregregs including glass fibers are composed of resin, whose melting temperature range is higher than that of resin composing the pregregs including carbon fibers.

In the core member, for example, the prepreg including carbon fibers may be formed by impregnating a woven cloth, which is composed of carbon fibers, with the resin; and the prepreg including glass fibers may be formed by impregnating a woven cloth, which is composed of glass fibers, with the resin. With this structure, strength of the core section can be improved, and a thermal expansion coefficient of the core member can be limited to a small value.

Further, the method of producing a core member comprises the steps of: preparing prepregs composed of resin including carbon fibers, prepregs composed of resin including glass fibers, and copper foils; providing the prepregs including glass fibers between the prepregs including carbon fibers and the copper foils; and heating and pressurizing the prepregs including carbon fibers, the prepregs including glass fibers and the copper foils so as to thermally cure the prepregs.

In the method, the pregregs including glass fibers are composed of resin, whose melting temperature range may be higher than that of resin composing the pregregs including carbon fibers. With this method, invasion of the resin from the prepregs including glass fibers to the prepregs including carbon fibers can be prevented when the core member is formed by performing the heating and pressuring step, so that the copper foils can be securely bonded on the carbon fiber-reinforced core section.

In the core member of the present invention, the copper foils are thermocompression-bonded on the both side faces of the carbon fiber-reinforced core section with the prepregs including glass fibers, and the pregregs including glass fibers are composed of the resin, whose melting temperature range is higher than that of the resin composing the pregregs including carbon fibers, so that the copper foils can be securely bonded to the carbon fiber-reinforced core section.

### BRIEF DESCRIPTION OF THE DRAWINGS

Embodiments of the present invention will now be described by way of examples and with reference to the accompanying drawings, in which:

FIGS. 1A and 1B are partial sectional views showing the steps of producing a core member;

FIGS. 2A-2C are partial sectional views showing the steps of producing a core substrate;

FIGS. 3A-3C are partial sectional views showing the further steps of producing the core substrate; and

FIG. 4 is a partial sectional view of a circuit board.

### DETAILED DESCRIPTION OF THE EMBODIMENTS

Preferred embodiments of the present invention will now be described in detail with reference to the accompanying drawings.

### (Method of Producing Core Member)

Firstly, a method of producing a core member will be explained.

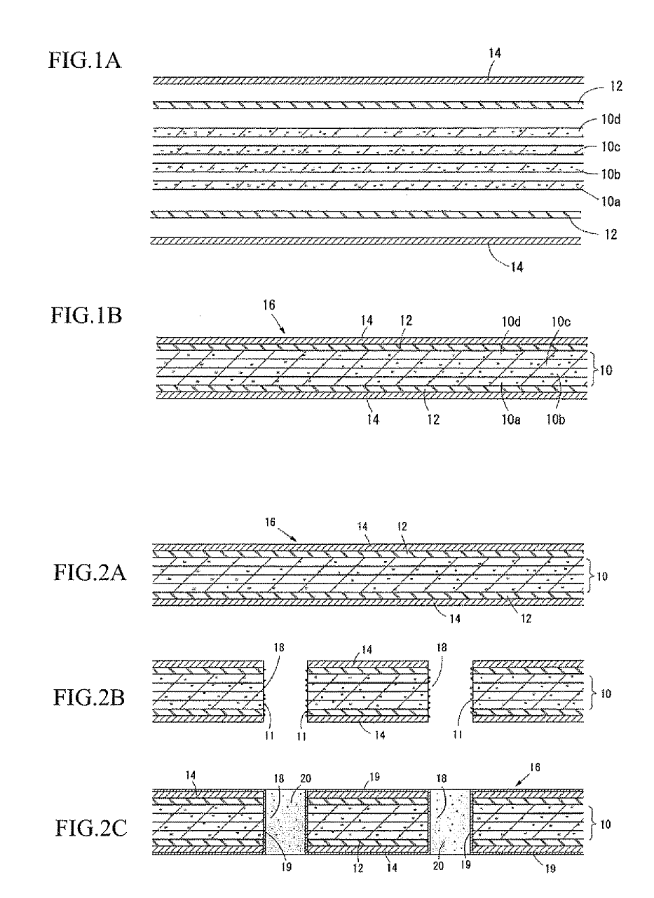

In FIG. 1A, prepregs 10a, 10b, 10c and 10d, prepregs 12 and copper foils 14, which constitute the core member, are laminated. The prepregs 10a, 10b, 10c and 10d are formed by impregnating carbon fibers with resin (polymer); the prepregs 12 are formed by impregnating glass fibers with resin. The copper foils 14 respectively cover the both side faces of the core member.

The prepregs 10a, 10b, 10c and 10d constitute a carbon fiber-reinforced core section. In the drawing, for example, four prepregs 10a, 10b, 10c and 10d are laminated. Number of laminating the prepregs forming the carbon fiber-reinforced core section may be defined according to a thickness of the core member, strength thereof, etc.

In the present embodiment, the prepregs 10a, 10b, 10c and 10d are formed by impregnating woven cloths, which are composed of carbon fibers formed into filaments, with epoxy resin and drying the cloths so as to put the epoxy resin into a B-stage condition. Thicknesses of the prepregs 10a, 10b, 10c and 10d depend on diameters of the carbon fibers. In the present embodiment, the thicknesses of the prepregs 10a, 10b, 10c and 10d are about 20 μm.

The prepregs 12 are respectively provided between the prepregs 10a-10d and the copper foils 14. In the present embodiment, the prepregs 12 are formed by impregnating woven cloths, which are composed of glass fibers, with epoxy resin and drying the cloths so as to put the epoxy resin into the B-stage condition. In the present embodiment, the thicknesses of the prepregs 12 are about 60-100 μm.

The prepregs 12 including glass fibers are used so as not to reduce the strength of the core member and so as to limit thermal expansion coefficient thereof to a small value. Thermal coefficients of carbon fibers are about 0 ppm/° C.; thermal coefficients of the cured prepregs 10a-10d including carbon fibers are 1-2 ppm/° C. By impregnating glass fibers with the resin, the thermal expansion coefficients of the cured prepregs 12 are 12-16 ppm/° C.

The copper foils 14 covering the outer side faces of the core member are formed so as to protect the surfaces of the core member, use as an electric power feeding layer for plating the core member and improve bonding strength between the core member and cable layers, which are laminated on the both side faces of the core member when the core substrate is formed. Thicknesses of the copper foils 14 are 20-35 μm.

In FIG. 1B, the prepregs 10a-10d, the prepregs 12 and the copper foils 14, which have been laminated in the step shown in FIG. 1A, are heated and pressurized so as to cure the resin included in the prepregs 10a-10d and 12 and form a flattened core member 16. In the core member 16, the copper foils 14 are integrally bonded on the both side faces of the carbon fiber-reinforced core section 10, in which the prepregs 10a-10d are integrated, with the prepregs 12.

The core member 16 of the present embodiment is characterized in that the copper foils 14 are integrally bonded on the both side faces of the carbon fiber-reinforced core section 10 with the prepregs 12 including glass fibers.

Since the prepregs 10a-10d constituting the carbon fiber-reinforced core section 10 are formed by impregnating carbon fibers with the resin, the prepregs 10a-10d have predetermined bonding strength. Therefore, in case of bonding the copper foils 14 onto the surfaces of the carbon fiber-reinforced core section 10, the copper foils 14 may be bonded by laminating the copper foils 14 onto the outer surfaces of the prepregs 10a-10d and heating and pressurizing them.

However, under some conditions of heating and pressurizing the prepregs 10a-10d and the copper foils 14, the resin of the prepregs 10a-10d invade into the carbon fiber-reinforced core section 10, an amount of the resin applied to the carbon fiber-reinforced core section 10 and the copper foils 14 are reduced, and the copper foils 14 are insufficiently bonded on the carbon fiber-reinforced core section 10. In the present embodiment, the prepregs 12 including glass fibers are provided between the carbon fiber-reinforced core section 10 and the copper foils 14 so as to securely apply enough amount of the resin therebetween and securely bond the copper foils 14 to the carbon fiber-reinforced core section 10.

To further securely bond the copper foils 14 to the carbon fiber-reinforced core section 10, in the present embodiment, the resin of the prepregs 10a-10d, which include carbon fibers, and the resin of the prepregs 12, which include glass fibers, have different temperature ranges of minimum viscosities (or melting temperature ranges) as shown in TABLE 1.

TABLE 1

| | Melting Temperature | Melting Viscosity |
|---|---|---|
| Prepreg | (° C.) | (Pa · s) |
| Resin in Carbon Fibers | 120-140 | 100-150 |
| Resin in Glass Fibers | 140-160 | 100-200 |

Generally, a melting temperature (temperature range) of resin can be changed by changing amounts of resin components, an additive solvent, etc. Various kinds of epoxy resin having different melting temperatures are provided. Therefore, suitable prepregs including carbon fibers and suitable prepregs including glass fibers can be formed by selecting resin.

As shown in TABLE 1, the melting temperature (temperature range) of the resin of the prepregs 12 is higher than that of the resin of the prepregs 10a-10d including carbon fibers. In case that the melting temperature of the resin of the prepregs 12 is higher than that of the resin of the prepregs 10a-10d including carbon fibers, by heating and pressurizing the prepregs, firstly the prepregs 10a-10d including carbon fibers are melted, and then the prepregs 12 including glass fibers are melted.

While melting viscosity of the prepregs 12 including glass fibers is minimum, the prepregs 10a-10d including carbon fibers start to cure and their melting viscosity is higher than that of the prepregs 12 including glass fibers. Therefore, invasion of the resin from the prepregs 12 to the core section 10 can be prevented.

Under the conditions shown in TABLE 1, a pressurizing jig is heated to about 150-160° C., and hot press may be performed with the jig. By performing the hot press, a work piece is gradually heated to about 150-160° C., but the viscosity of the prepregs 10a-10d including carbon fibers firstly reaches the minimum, and then the viscosity of the prepregs 12 including glass fibers reaches the minimum. Therefore, transferring the resin from the glass fibers to the carbon fibers can be restrained, enough amount of the resin for bonding the copper foils 14 to the core section 10 can be secured, so that the copper foils 14 can be securely bonded onto the core section 10.

Timing of softening the resin of the prepregs 10a-10d including carbon fibers and timing of softening the resin of the prepregs 12 including glass fibers are overlapped, so that bonding strength in boundary surfaces therebetween can be secured.

The prepregs 10a-10d including carbon fibers firstly start to cure, and then the prepregs 12 including glass fibers gradually cure from the minimum viscosity. Finally, the prepregs 10a-10d including carbon fibers and the prepregs 12 including glass fibers perfectly cure, and the flattened core member 16 shown in FIG. 1B can be gained.

In the core member 16, the copper foils 14 are bonded onto the carbon fiber-reinforced core section 10 with the prepregs 12 including glass fibers. The copper foils 14 can be bonded on the carbon fiber-reinforced core section 10 with enough bonding strength.

In the above described embodiment, each of the prepregs 10a-10d including carbon fibers is constituted by the woven cloth composed of carbon fiber filaments. Further, unwoven carbon fiber cloths, carbon fiber meshes, etc. may be used as the prepregs 10a-10d depending on uses.

Further, the prepregs 12 may include fillers, e.g., alumina fillers, instead of glass fibers.

Note that, in the above described embodiment, the melting temperature range of the prepregs 10a-10d and the melting temperature range of the prepregs 12 are not overlapped. In case that the melting temperature ranges of the two are slightly overlapped, the above described effects can be gained. Further, if there is not a significant difference between the melting viscosities of the two, the above described effects can be gained.

### (Core Substrate)

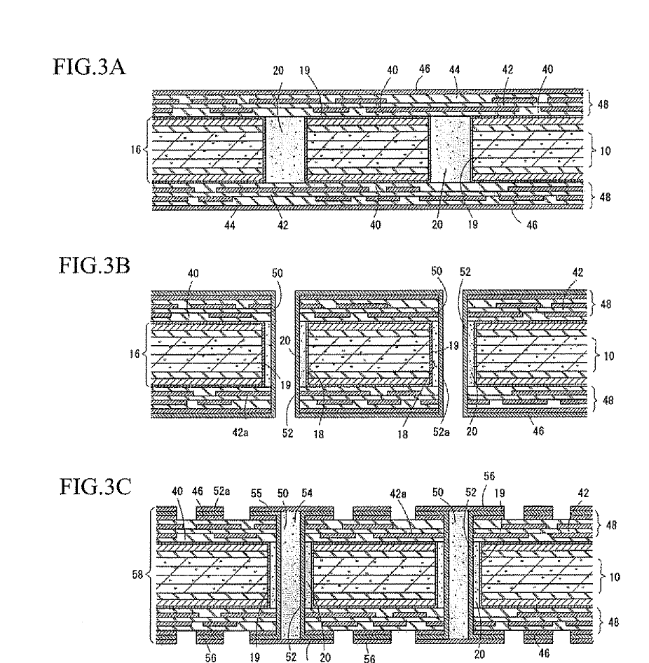

FIGS. 2A-2C and 3A-3C show the steps of producing the core substrate having the core member 16.

FIG. 2A shows the core member 16.

In FIG. 2B, pilot holes 18 are bored, by a drill, in the core member 16.

When the pilot holes 18 are drilled, burrs are formed on inner faces of the pilot holes 18 by, for example, abrasion of the drill, and drill dusts 11 stick on the inner faces of the pilot holes 18. Thus, after forming the pilot holes 18 in the core member 16, the core member 16 is electroless-plated with copper and electrolytic-plated with copper so as to coat the inner faces of the pilot holes 18 with plated layers 19.

In FIG. 2C, after coating the inner faces of the pilot holes 18 with the plated layers 19, the pilot holes 18 are filled with insulating resin 20. By coating the inner faces of the pilot holse 18 with the plated layers 19, mixing the dusts 11 with the resin 20 can be prevented, and an insulating property of the resin 20 can be secured.

In FIG. 3A, prepregs 40, cable sheets 42, prepregs 44 and copper foils 46 are arranged and laminated, in this order, on the both side faces of the core member 16. Then, they are heated and pressurized, so that cable layers 48 are integrally laminated on the core member 16.

In FIG. 3B, through-holes 50, which are coaxial with the pilot holes 18, are bored, by a drill, so as to form electrically conductive through-holes. Further, electroless copper plating and electrolytic copper plating are performed so as to form the electrically conductive through-holes 52. A diameter of the through-holes 50 is smaller than that of the pilot holes 18. Plated layers 52a coating inner faces of the through-holes 50 are electrically conductive parts of the conductive through-holes 52.

In FIG. 3C, the through-holes 50 are filled with resin 54, the copper foils 46, the plated layers 52a and cap-plated layers 55, which are formed on the both sides, are pattern-etched so as to form a core substrate 58, in which cable patterns 56 are formed on the both side faces.

The cable patterns 56 formed on the both side faces of the core substrate 58 are mutually electrically connected by the conductive through-holes 52. Cable patters 42a formed in the cable layers 48 are connected to the conductive through-holes 52 at suitable positions.

### (Circuit Board)

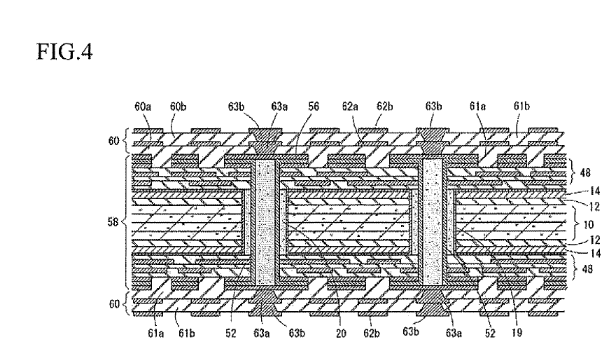

A multi-layered circuit board can be produced by forming the cable pattern layers on the both side faces of the core substrate shown in FIG. 3C. FIG. 4 is a partial sectional view of the circuit board, in which cable patterns are multi-layered.

The cable pattern layers can be multi-layered on the both side faces of the core substrate 58 by, for example, a build-up method. In FIG. 4, two-layered build-up layers 60 are formed. Each of first build-up layers 60a includes: an insulating layer 61a; a cable pattern 62a formed on a surface of the insulating layer 61a; and vias 63a mutually connecting the cable patterns 56 and 62a formed in the different layers. Each of second build-up layers 60b includes: an insulating layer 61b; a cable pattern 62b; and vias 63b.

The cable patterns 62a and 62b, which are included in the build-up layers 60 formed on the both side faces of the core substrate 58, are mutually electrically connected by the conductive through-holes 52 and the vias 63a and 63b.

The conductive through-holes 52 are formed in the pilot holes 18, and the conductive carbon fiber-reinforced core section 10 and the conductive through-holes 52 are not electrically shorted. The copper foils 14 are bonded on the surfaces of the carbon fiber-reinforced core section 10 with the prepregs 12 described above. The carbon fiber-reinforced core section 10, the prepregs 12 and the copper foils 14 constitute the core member 16.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A core member,
comprising:
a carbon fiber-reinforced core section, in which prepregs including carbon fibers are thermocompression-bonded; and
copper foils being respectively thermocompression-bonded on the both side faces of the carbon fiber-reinforced core section with prepregs including glass fibers,
wherein the pregregs including glass fibers are composed of resin, whose melting temperature range is higher than that of resin composing the pregregs including carbon fibers.

2. The core member according to claim 1,
wherein the prepreg including carbon fibers is formed by impregnating a woven cloth, which is composed of carbon fibers, with the resin.

3. The core member according to claim 1,
wherein the prepreg including glass fibers is formed by impregnating a woven cloth, which is composed of glass fibers, with the resin.

4. A method of producing a core member,
comprising the steps of:
preparing prepregs composed of resin including carbon fibers, prepregs composed of resin including glass fibers, and copper foils;
providing the prepregs including glass fibers between the prepregs including carbon fibers and the copper foils; and
heating and pressurizing the prepregs including carbon fibers, the prepregs including glass fibers and the copper foils so as to thermally cure the prepregs.

5. The method according to claim 4,
wherein the pregregs including glass fibers are composed of resin, whose melting temperature range is higher than that of resin composing the pregregs including carbon fibers.

6. The method according to claim 4,
wherein the prepreg including carbon fibers is formed by impregnating a woven cloth, which is composed of carbon fibers, with the resin.

7. The method according to claim 4,
wherein the prepreg including glass fibers is formed by impregnating a woven cloth, which is composed of glass fibers, with the resin.
